(19) United States
(12) Patent Application Publication
(10) Pub. No.: US 2013/0070257 A1
(43) Pub. Date: Mar. 21, 2013

(54) Three-Dimensional Scanning System

(71) Applicant: Cheung Fai WONG, Hong Kong (HK)

(72) Inventor: Cheung Fai WONG, Hong Kong (HK)

(73) Assignee: FIDELITY ART RESEARCH LIMITED, Hong Kong (HK)

(21) Appl. No.: 13/235,493

(22) Filed: Sep. 18, 2011

(51) Int. Cl. G01B 11/24

(52) U.S. Cl. 356/601

(57) ABSTRACT

The present invention provides a three dimensional scanning system for generating a three dimensional profile of an object being scanned. The scanning system comprises a light source, a beam splitter, a first reflector, a second reflector, a detector, a driving member and a processor, for generating a profile of the object based on the detection signal and the track of movement of the object. The present invention can be used for scanning objects with reflective surface and large size and is able to collect the accurate outlook of an object even though its surface is obscured

### FIELD OF INVENTION

This invention relates to a scanning system, and in particular a three dimensional scanning system for generating a three dimensional profile of an object being scanned.

### BACKGROUND OF INVENTION

Scanning systems have been widely used in various industries for product manufacturing and quality control, etc. Scanning systems can be used to analyze a real-world object or environment to collect data on its shape and possibly its appearance. The data collected can then be used to construct profiles of the objects or even three dimensional (3D) models of the objects. The technique of scanning can be used in many applications, including industrial design, reverse engineering, quality control and documentation of cultural artifacts, etc.

However, the existing scanning systems lack appropriate design. If the surface of the object to be scanned is reflective, such scanning systems may not function well and the scanning result may not be accurate. Confocal scanning system may solve the problem of reflective surface but it is limited for scanning objects with small size. Another problem of the existing scanning systems is that they can only collect information about surfaces that are not obscured.

### SUMMARY OF INVENTION

In the light of the foregoing background, it is an object of the present invention to provide an alternate scanning system that can be used for scanning objects with reflective surface and large size and is able to collect the accurate outlook of an object even though its surface is obscured.

Accordingly, the present invention, in one aspect, is a scanning system comprising a light source adapted to emit a source beam of light; a beam splitter adapted to split the source beam emitted by the light source into a first beam and a second beam; a first reflector adapted to reflect the first beam onto an object to be scanned; a second reflector adapted to reflect the second beam onto the same object; a detector adapted to detect a reflected beam comprising at least one of the first beam and the second beam reflected from the object and generate a detection signal therefor; a driving member adapted to drive the object to move such that the reflected beam can be detected by the detector, the object being fixedly attachable to the driving member; and a processor adapted to receive the detection signal from the detector and generate a profile of the object.

In an exemplary embodiment of the present invention, the light source of the scanning system is a laser emitter and the beam emitted by the light source is planar. The driving member is adapted to drive the object to move in a vertical direction and/or move in a horizontal direction and the profile of the object is a three dimensional profile of a specific face of the object. The three dimensional profile of the specific face is generated based on the detection signal and the track of movement of the object. An overall three dimensional profile of the object is created based on a plurality of the three dimensional profiles of different faces of the object.

In another exemplary embodiment, the scanning system further comprises an adjustor adapted to adjust the light source to emit the source beam of light onto the beam splitter in a vertical direction, and comprises a recorder adapted to record the track of adjustment of the light source and transmit the track to the processor for processing. The driving member drives the object to move in a horizontal direction and the track of movement of the object is recorded and transmitted to the processor. The profile is generated based on the detection signal, the track of movement of the object and the track of adjustment of the light source. The profile is a three dimensional profile of a specific face of the object. An overall three dimensional profile of the object is created based on a plurality of three dimensional profiles of different faces of the object.

In another implementation, the scanning system further comprising a third reflector and a fourth reflector. The third reflector is adapted to receive and reflect the reflected beam to the fourth reflector and the fourth reflector is adapted to receive the reflected beam from the third reflector and reflect the reflected beam to the detector.

In yet another embodiment, the detector is a line-scan camera. The beam splitter is adapted to reflect half of intensity of the source beam into the first beam and transmit the remaining half of intensity of the source beam into the second beam.

In another embodiment, the scanning system further comprises an oscillating mirror adapted to receive the source beam of light and reflect the source beam of light onto the beam splitter. There is a mirror adjustor adapted to drive the oscillating mirror to reflect the source beam of light onto the beam splitter in a vertical direction. The driving member drives said object to move in a horizontal direction and the track of movement of the object is recorded and transmitted to the processor. The profile of the object is generated based on the detection signal, the track of movement of the object and the track of adjustment of the oscillating mirror. The profile is a three dimensional profile of a specific face of said object. An overall three dimensional profile of the object is created based on a plurality of the three dimensional profiles of different faces of the object.

According to another aspect, the present invention is a method for scanning an object and generating a profile of the object comprising the steps of: emitting a source beam of light; splitting the source beam of light into a first beam and a second beam; reflecting the first beam and the second beam onto the object; driving the object to move such that a reflected beam comprising at least one of the first beam and the second beam reflected from the object can be detected by a detector; detecting the reflected beam by the detector, and generating a detection signal therefor; and receiving the detection signal and generating the profile of the object.

In an embodiment, the method further comprises driving the object to move in a vertical direction and/or move in horizontal direction; generating a three dimensional profile of a specific face of the object; and creating an overall three dimensional profile of the object based on a plurality of three dimensional profiles of different faces of the object.

In a variation, the method further comprises adjusting the source beam of light in a vertical direction and recording the track of adjustment of the source beam of light; generating a three dimensional profile of a specific face of the object based on a detection signal generated by the detecting step, a track of movement of the object recorded by the driving step and the track of adjustment of the source beam of light; and creating an overall three dimensional profile of the object based on a plurality of the three dimensional profiles of different faces of the object.

In another embodiment, the splitting step of the method comprises splitting half of intensity of the source beam of light into the first beam and splitting the remaining half of intensity of the source beam of light into the second beam.

There are many advantages to the present invention. For example, the first beam and second beam are separated from the same source beam and thus synchronization of these two beams can be easily manipulated. Second, the scanning system of the present invention can perform accurate scanning on any surface of the object regardless of whether it is reflective or not. The present invention is not limited to scan small objects but also large objects.

Moreover, by using two synchronized beams separated from the same source beam, the present invention can collect an accurate profile of the object even though the surface of the object is obscured. An overall three-dimensional profile of the object can 105 thus be obtained and the accuracy of the overall three-dimensional profile can be adjusted by varying the number of faces of the object to be scanned.

### BRIEF DESCRIPTION OF FIGURES

FIG. 1 is a structural diagram of the scanning system according to one embodiment of the present invention.

FIG. 2 is an exemplary implementation of the light source according to one embodiment of the present invention.

FIG. 3 shows a diagram illustrating the scanning theory of the present invention.

FIG. 4 shows a three-dimensional diagram of an object to be scanned according to one embodiment of the present invention.

FIG. 5 is a height profile of a scanned object according to one embodiment of the present invention.

FIG. 6 is a diagram illustrating the working theory of scanning an object with a hole on its surface according to an embodiment of the present invention.

### DETAILED DESCRIPTION OF THE PREFERRED EMBODIMENTS

As used herein and in the claims, “comprising” means including the following elements but not excluding others.

As used herein and in the claims, “Y axis” or “vertical direction” refers to the direction aligned with the direction of the force of gravity. “X axis” or “horizontal direction” refers to the direction perpendicular to “Y axis”.

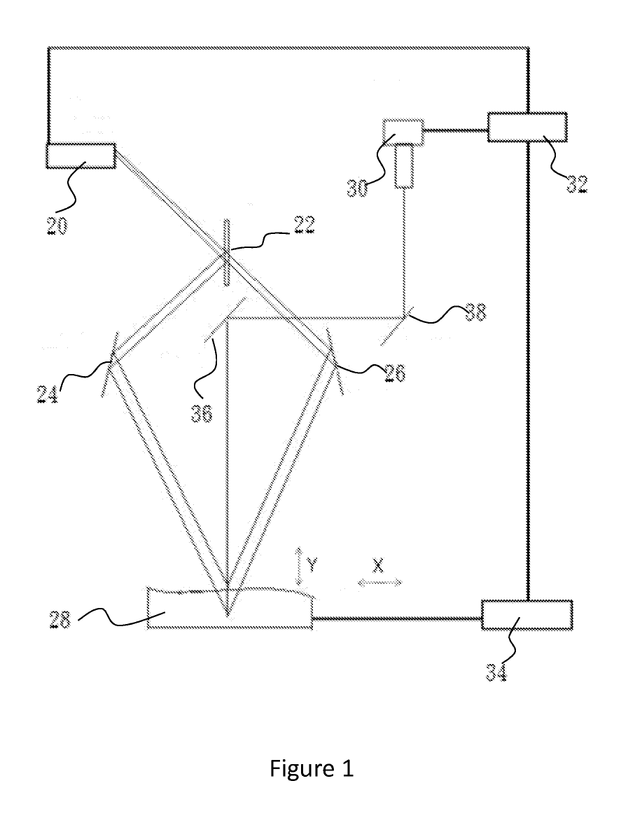

Referring now to FIG. 1, a structural diagram of the scanning system according to one embodiment of the present invention is shown. The present invention comprises a light source 20, a beam splitter 22, a first reflector 24, a second reflector 26, a detector 30, a driving member 34 attached to an object 28 and a processor 32.

In a first embodiment, the light source 20 is adapted to emit a source beam of light onto the beam splitter 22. The light source 20 is a laser emitter and the emitted source beam is planar in one embodiment of the present invention. The beam splitter 22 divides the source beam into a first beam and a second beam. The beam splitter 22 functions by reflecting a part of the source beam as the first beam and transmitting the remaining part of the source beam as the second beam. In one embodiment, the beam splitter 22 reflects half intensity of the source beam into the first beam and transmits the remaining half intensity of the source beam into the second beam. The first reflector 24 reflects the first beam onto the object 28 while the second reflector 26 reflects the second beam onto the same object 28. Afterwards, the detector 30 detects a reflected beam which comprises at least one of the first beam and the second beam reflected from the object 28. In general, the reflected beam detected by the detector 30 contains both the first beam and the second beam reflected from the object 28. However, in some cases, the detector 30 only detects the first beam or the second beam reflected from the object 28. When the detector 30 detects the reflected beam, it will generate a detection signal and send the signal to the processor 32 for further processing.

In one embodiment, the driving member 34 and the object 28 are interconnected and the driving member 34 can drive the object 28 to move in the vertical direction and/or the horizontal direction respectively such that the first beam and the second beam can irradiate on any part of the surface of the object 28. As such, the light source 20 and the detector 30 can be fixed while the object 28 can be scanned properly by suitable adjustment on the driving member 34. During the scanning process, the driving member 34 records the moving track of the object 28 and will send the track of movement to the processor 32 for processing. Based on the detection signal sent by the detector 30 and the track of movement sent by the driving member 34, the processor 32 generates a profile of the object 28. The profile thus generated is three-dimensional (3D).

In another embodiment, the scanning system of the present invention further comprises a third reflector 36 and a fourth reflector 38. The third reflector 36 is adapted to receive and reflect the reflected beam from the object 28 to the fourth reflector 38. And then the fourth reflector 38 receives the reflected beam from the third reflector 36 and reflects the reflected beam to the detector 30. The addition of the third reflector 36 and the fourth reflector 38 guarantees that the reflected beam can be detected by the detector 30 properly without the interference of other beams since the third reflector 36 and the fourth reflector 38 can adjust the direction of the reflected beam if needed.

In yet another embodiment, the scanning system of the present invention further comprises an adjustor (not shown) which is connected to the light source 20. The adjustor is used to adjust the light source 20 to emit the source beam onto the beam splitter 22 in the vertical direction. There is also a recorder for recording the track of adjustment of the light source 20 and the track of adjustment will be transmitted to the processor 32 for processing. In this embodiment, the driving member 34 only drives the object 28 to move in the horizontal direction and records the horizontal moving track of the object 28. The processor 32 will generate the profile of the object 28 based on the detection signal sent by the detector 30, the track of adjustment of the light source 20 and the horizontal moving track of the object 28.

In one embodiment, the processor 32 is a personal computer, a server or other computing devices with a central processing unit. The profile generated can be displayed or processed for further analysis. In an exemplary embodiment, the detector 30 is a line-scan camera. Compared to using normal laser detector, line-scan camera has a higher resolution and the images collected are more accurate. Moreover, the line-scan camera can be a high-speed line-scan camera.

Traditional scanning systems cannot function well if the surface of the object to be scanned is reflective. The object is needed to be coated with non-reflective material. The present invention can perform an accurate scanning even though the surface of the object is reflective. With the use of a line-scan camera (i.e. the detector) to detect the reflected beam in the present invention, a single line on the scanned face of the object can only be detected. Any area beyond this single line of detection will not be recognized and thus no matter such area is reflective or not, the signal detected is not affected. Thus coating is not needed and the accuracy of scanning is increased. The present invention can also be used to scan objects with larger size since the beam emitted by the light source 20 can be adjusted in a vertical direction, therefore realizing the adjustment of scanning depth (i.e. height) of the object to be scanned. Therefore the scanning system of the present invention can be used for scanning larger objects.

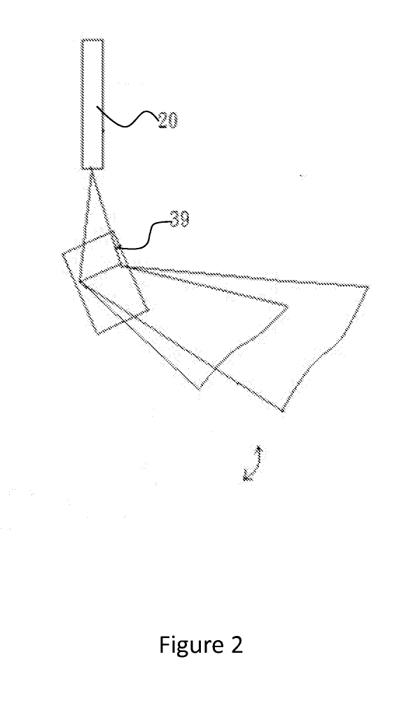

Referring now to FIG. 2 which is an exemplary implementation of the light source 20 according to one embodiment of the present invention. In this embodiment, the light source 20 is a laser emitter and there is an oscillating mirror 39 which receives the source beam emitted by the laser emitter and reflects the source beam onto the beam splitter 22. The laser emitter can emit laser line curtain which is planar. By using laser line curtain, the scanning speed can be increased. In another embodiment, the laser emitter can emit point light. There is also a mirror adjustor (not shown) connected to the oscillating mirror 39. The mirror adjustor is used to drive the oscillating mirror 39 to continuously move up and down and thus reflect the source beam emitted by the laser emitter onto the beam splitter 22 in a vertical direction. In this embodiment, the light source 20 is fixed and not movable.

There is also an adjustment decoder (not shown) connected between the oscillating mirror 39 and the processor 32. The adjustment decoder records the track of adjustment of the oscillating mirror 39 adjusted by the mirror adjustor and then transmits this track to the processor 32 for processing. Based on the track of adjustment of the oscillating mirror 39, the processor 32 can then compute the track of the intersection point of the first beam and the second beam, therefore acquiring the depth changes of the object 28, i.e. changes of Y axis. In other words, the profile of the object 28 is generated based on the detection signal, the track of movement of the object 28 and the track of adjustment of the oscillating mirror 39.

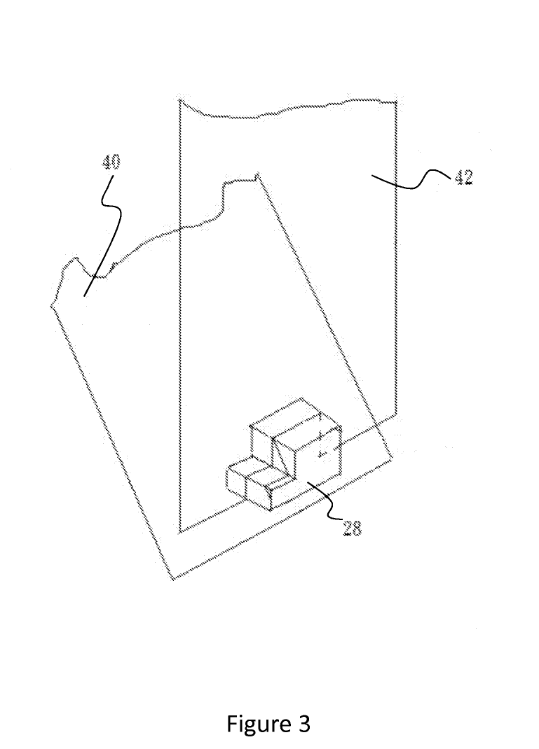

Now turning to the operation of the system described above, FIG. 3 shows a diagram illustrating the scanning theory of the present invention. The detector 30, preferably a line-scan camera, can only scan a width that is equal to the width of the planar laser line curtain emitted, which is the maximum data (width) that can be detected by the line-scan camera in a single capture. Usually the maximum width is more than enough and only the central line within that width is used for processing. To increase the scanning accuracy, a smaller width of the central line can be selected. As shown in FIG. 3, the detecting plane 42 of the line-scan camera intersects with the laser line curtain 40 that is irradiated on the object 28. Only the intersection between the detecting plane 42 and the laser line curtain 40 is captured by the line-scan camera. In order to simplify the explanation, only a single laser line curtain is shown in FIG. 3.

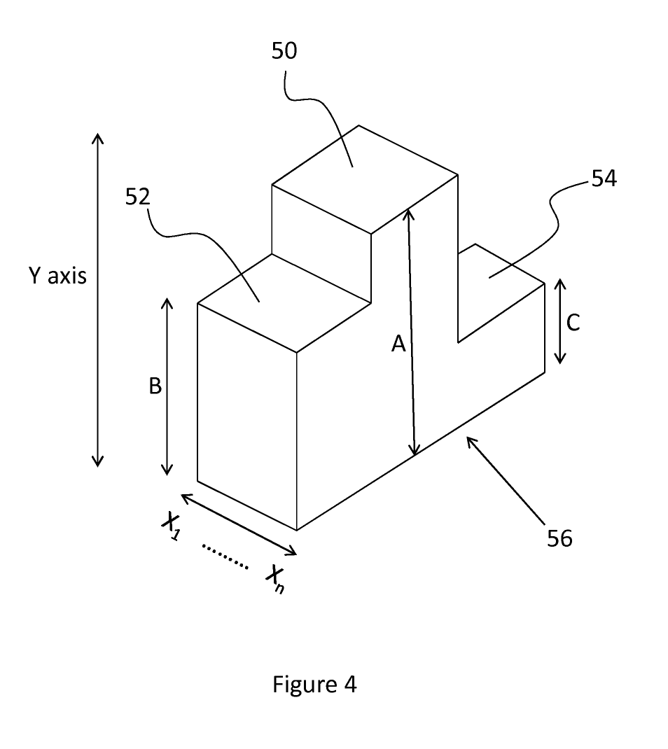

Referring to FIG. 4, the three-dimensional diagram of an object 56 (having a different shape as the object 28) is shown according to one embodiment of the present invention and used for illustrating the details of the scanning process. The first beam and the second beam irradiate onto the object 56 from the top of the object 56. In order to simplify the explanation, only the first beam is used in the following description. The system initiates the process by conducting a first vertical scan in which a first horizontal position (X₁ as shown) of the object 56 is fixed. Then the first beam will scan the object 56 along the vertical axis (i.e. the Y axis as shown) either by driving the object 56 to move in a vertical direction using the driving member 34, adjusting the light source 20 to emit the source beam in a vertical direction using the adjustor, or driving the oscillating mirror 39 in a vertical direction using the mirror adjustor. The first beam will first reach only the surface 50 with the height “A”, but the surface 52 with height “B” and the surface 54 with height “C” cannot be reached by the first beam at this horizontal position X₁. The first beam is then reflected by the surface 50 and detected by the detector 30. Subsequently, the detector 30 recognizes that the surface 50 is of the height “A”. The first beam then continues to move downward and once it reaches the surface 52 with height “B”, it is reflected to the detector 30 which recognizes the surface 52 having the height “B”. The process continues and finally the surface 54 is detected and identified to be of height “C”. When the first beam has finished scanning the whole object 56 along the vertical axis at the horizontal position X₁, all the levels with different heights of the object 56 at the horizontal position X₁ are collected and this completes the first vertical scan. A first height profile of the object 56 at horizontal position X₁ can then generated.

Afterwards, a second vertical scan begins in which the object 56 is adjusted to a second horizontal position (X₂) by the driving member 34. The scanning process is then repeated as mentioned above to obtain a second height profile of the object 56 at the horizontal position X₂. After a number of vertical scans (e.g. n times), the whole scanning process is finished and a total number of n height profiles of the object 56 are obtained. By combining all these height profiles of the object 56 layer by layer, a three dimensional profile of a specific face (the top face in this example) of the object 56 is generated.

In the scanning process of the above embodiment, the horizontal position of the object 56 is first fixed and then a vertical scan is conducted on the object 56 at that specific horizontal position. In yet another embodiment, an alternate scanning process can be employed in which the vertical position of the object 56 is first fixed, and then a horizontal scan is conducted on the object 56 at that specific vertical position by, for example, moving the object 56 along the horizontal axis for scanning.

As an example, if a single side of a coin is scanned, a 3D profile of that side of the coin is obtained, which shows the 3D structure of the pattern on that side. If an overall 3D profile of the object is desired, it can be created by scanning several faces of the object and then integrating all the 3D profiles of different faces of the object. Usually, scanning six faces of the object is sufficient to obtain a desired overall 3D profile. If higher accuracy is needed, more faces of the object can be scanned.

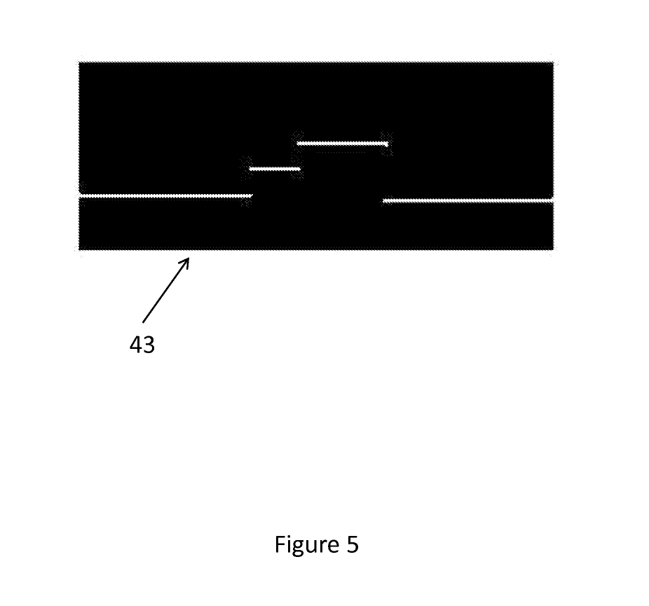

FIG. 5 shows a height profile 43 of a scanned object 28 according to one embodiment of the present invention. The bright lines in the height profile 43 indicate the height levels of the object 28. As mentioned above, by combining all the height profiles of the object 28 layer by layer, a three dimensional profile of a specific face of the object 28 is acquired.

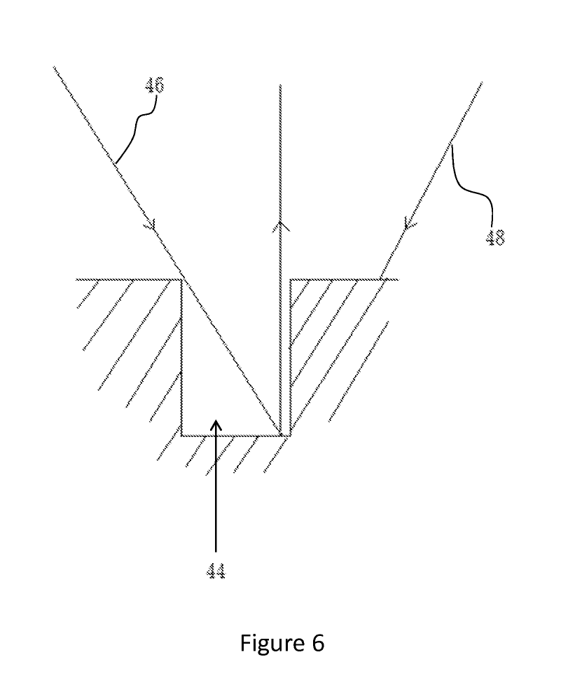

Now turning to FIG. 6 which shows a diagram illustrating the working theory of scanning an object with a hole 44 on its surface according to an embodiment of the present invention. The present invention only uses a single light source 20 and makes use of the beam splitter 22 for dividing the source beam emitted by the light source 20 into two resulting beams, the first beam and the second beam. By doing so, it is guaranteed that the first beam and the second beam are synchronized since they are split from the same source beam. If two light sources are used, synchronization of the two source beams should be taken care of and it may be difficult on handling such synchronization. Another advantage of using two synchronized beams is that for an object with a hole on its surface, at least one of the two beams can be irradiated into the hole and reflected from the hole so that the detector 30 can recognize the hole. As shown in FIG. 6, if the second beam 48 is blocked, the first beam 46 can still reach into the hole and then is reflected to the detector 30, and vice versa. Consequently, the present invention can increase the accuracy of the 3D profile generated. The existing scanning systems usually irradiate a single source beam onto the object. If there is a hole on the object to be scanned, the reflected beam may not be detected by the detector because the unique source beam may be blocked by the hole, resulting in inaccuracy of the 3D profile generated.

The exemplary embodiments of the present invention are thus fully described. Although the description referred to particular embodiments, it will be clear to one skilled in the art that the present invention may be practiced with variation of these specific details. Hence this invention should not be construed as limited to the embodiments set forth herein.

For example, the beam splitter 22 can reflect and transmit the source beam in different proportion according to need of the user, say 20% intensity of the source beam being reflected and 80% intensity of the source beam being transmitted, or 40% intensity of the source beam being reflected and 60% intensity of the source beam being transmitted. By using different proportion of the first beam and the second beam, the detector can identify the beam detected is the first beam, the second beam or any combination thereof.

The angle between the first beam and the second beam can be varied, for instance, the angle between the first beam 46 and the second beam 48 can be adjusted under different circumstances. For example, referring to FIG. 6, if the hole 44 has a greater depth, a smaller angle would be required so that either or both of the first beam 46 and the second beam 48 can reach the bottom of the hole 44. In one embodiment, the angle is between 30° to 150°. In one preferred embodiment, the angle is between 60° to 90° which is the optimal range for most of the circumstances. The angle adjustment can be carried out, for example, by adjusting the reflectors 24 and 26.

The X axis and Y axis from which the scanning is based thereupon are for ease of illustration and it is clear that other pair of axes can also be used as long as the two axes are orthogonal to each other.

The oscillating mirror 39 used is not limited to mirror only; for example, a reflector, a lens, etc can also be used according to the desire of the user.

As illustrated in FIG. 1, two additional reflectors, namely the third reflector 36 and the fourth reflector 38, are used for further reflecting the beams to the detector 30. However, it is clear to one skilled in the art that the number of these additional reflectors can be varied according to the desire and/or need of the user. In another embodiment, such additional reflectors can also be removed from the system and the resulting detection would not be affected.

What is claimed is:

1. A scanning system comprising:
a) a light source adapted to emit a source beam of light;
b) a beam splitter adapted to split said source beam emitted by said light source into a first beam and a second beam;
c) a first reflector adapted to reflect said first beam onto an object to be scanned;
d) a second reflector adapted to reflect said second beam onto said object;
e) a detector adapted to detect a reflected beam comprising at least one of said first beam and said second beam reflected from said object and generate a detection signal therefor;
f) a driving member adapted to drive said object to move such that said reflected beam can be detected by said detector, said object being fixedly attachable to said driving member; and
g) a processor adapted to receive said detection signal from said detector and generate a profile of said object.

2. The scanning system of claim 1 wherein said light source is a laser emitter and said beam is planar.

3. The scanning system of claim 1 wherein said driving member is adapted to drive said object to move in a vertical direction and/or move in a horizontal direction, said profile of said object is a three dimensional profile of a specific face of said object.

4. The scanning system of claim 3 wherein said three dimensional profile of said specific face is generated based on said detection signal and the track of movement of said object; an overall three dimensional profile of said object is created based on a plurality of said three dimensional profiles of different faces of said object.

5. The scanning system of claim 1 further comprising an adjustor adapted to adjust said light source to emit said source beam of light onto said beam splitter in a vertical direction.

6. The scanning system of claim 5 further comprising a recorder adapted to record the track of adjustment of said light source and transmit said track to said processor for processing.

7. The scanning system of claim 6 wherein said driving member drives said object to move in a horizontal direction and the track of movement of said object is recorded and transmitted to said processor.

8. The scanning system of claim 7 wherein said profile is generated based on said detection signal, said track of movement of said object and said track of adjustment of said light source; said profile is a three dimensional profile of a specific face of said object; an overall three dimensional profile of said object is created based on a plurality of three dimensional profiles of different faces of said object.

9. The scanning system of claim 1 further comprising a third reflector and a fourth reflector wherein said third reflector is adapted to receive and reflect said reflected beam to said fourth reflector; said fourth reflector is adapted to receive said reflected beam from said third reflector and reflect said reflected beam to said detector.

10. The scanning system of claim 1 wherein said detector is a line-scan camera.

11. The scanning system of claim 1 wherein said beam splitter is adapted to reflect half of intensity of said source beam into said first beam and transmit the remaining half of intensity of said source beam into said second beam.

12. The scanning system of claim 1 further comprising an oscillating mirror adapted to receive said source beam of light and reflect said source beam of light onto said beam splitter; and a mirror adjustor adapted to drive said oscillating mirror to reflect said source beam of light onto said beam splitter in a vertical direction.

13. The scanning system of claim 12 wherein said driving member drives said object to move in a horizontal direction and the track of movement of said object is recorded and transmitted to said processor.

14. The scanning system of claim 13 wherein said profile of said object is generated based on said detection signal, said track of movement of said object and the track of adjustment of said oscillating mirror; said profile is a three dimensional profile of a specific face of said object; an overall three dimensional profile of said object is created based on a plurality of said three dimensional profiles of different faces of said object.

15. A method for scanning an object and generating a profile of said object comprising the steps of:
a) emitting a source beam of light;
b) splitting said source beam of light into a first beam and a second beam;
c) reflecting said first beam and said second beam onto said object;
d) driving said object to move such that a reflected beam comprising at least one of said first beam and said second beam reflected from said object can be detected by a detector;
e) detecting said reflected beam by said detector, and generating a detection signal therefor; and
f) receiving said detection signal and generating said profile of said object.

16. The method of claim 15 further comprising driving said object to move in a vertical direction and/or move in horizontal direction; generating a three dimensional profile of a specific face of said object; and creating an overall three dimensional profile of said object based on a plurality of three dimensional profiles of different faces of said object.

17. The method of claim 15 further comprising adjusting said source beam of light in a vertical direction and recording the track of adjustment of said source beam of light.

18. The method of claim 17 further comprising generating a three dimensional profile of a specific face of said object based on a detection signal generated by said detecting step, a track of movement of said object recorded by said driving step and said track of adjustment of said source beam of light; and creating an overall three dimensional profile of said object based on a plurality of said three dimensional profiles of different faces of said object.

19. The method of claim 15 wherein said splitting step comprises splitting half of intensity of said source beam of light into said first beam and splitting the remaining half of intensity of said source beam of light into said second beam.

20. A three dimensional scanning system comprising:
a) a light source adapted to emit a source beam of light which is adjustable in a vertical direction;
b) a beam splitter adapted to split said source beam emitted by said light source into a first beam and a second beam;
c) a first reflector adapted to reflect said first beam onto an object to be scanned;
d) a second reflector adapted to reflect said second beam onto said object;
e) a detector adapted to detect a reflected beam comprising at least one of said first beam and said second beam reflected from said object and generate a detection signal therefor;
f) a driving member adapted to drive said object to move in a horizontal direction, said object being fixedly attachable to said driving member;
g) a processor adapted to receive said detection signal from said detector and generate a profile of said object;
h) a third reflector and a fourth reflector wherein said third reflector is adapted to receive and reflect said reflected beam to said fourth reflector; said fourth reflector is adapted to receive said reflected beam from said third reflector and reflect said reflected beam to said detector;
i) an oscillating mirror adapted to receive said source beam of light and reflect said source beam of light onto said beam splitter; and a mirror adjustor adapted to drive said oscillating mirror to reflect said source beam of light onto said beam splitter in a vertical direction and record the track of adjustment of said oscillating mirror;
wherein said light source is a laser emitter and said source beam of light is planar; said profile of said object is a three dimensional profile of a specific face of said object and said three dimensional profile is generated based on said detection signal, the track of movement of said object and said track of adjustment of said oscillating mirror; an overall three dimensional profile of said object is created based on a plurality of said three dimensional profiles of different faces of said object.
